(19) United States
(12) Patent Application Publication
(10) Pub. No.: US 2010/0003655 A1
(43) Pub. Date: Jan. 7, 2010

(54) Male toddler toilet training aid

(75) Inventor: Samuel S. Stephenson, JR., Fort Lauderdale, FL (US)

Correspondence Address: Samuel S. Stephenson, 805 SE 10th Street, Fort Lauderdale, FL, 33316, US

(73) Assignee: Samuel S. Stephenson, JR., Fort Lauderdale, FL (US)

(21) Appl. No.: 12/217,489

(22) Filed: Jul. 7, 2008

(51) Int. Cl. G09B 19/00; A47K 17/00

(52) U.S. Cl. 434/258; 4/661

(57) ABSTRACT

The present invention provides for a toilet training aid that is temporarily applied inside an existing toilet bowl or urinal in order to help teach male toddlers (or any age) to aim their stream of urine inside the toilet bowl or urinal. The toilet training aid is uniquely designed help keep male toddlers concentration by giving the toddler a target to aim at in the toilet bowl or urinal while allowing him to work on his hand and eye coordination of hitting the target in the toilet bowl or urinal. Thus the toilet training aid expedites the process of teaching male toddlers to control their stream of urine into the toilet bowl or urinal while making it a positive experience.

### FIELD OF INVENTION

The present invention relates to a toilet training aid that can be applied temporarily to the inside of an existing toilet or urinal in order to help teach male toddlers or any other age how to aim their stream of urine into a toilet or urinal.

### BACKGROUND OF THE INVENTION

Part of the maturing process for a male toddler going from diapers to underwear is learning to urinate into a toilet or urinal. Generally for boys, the transition from diapers to underwear occurs at the age of two to three years old. Typically, at this age boys do not have a very long attention span and their hand and eye coordination has not fully developed. As a result, male toddlers in the beginning stages of learning to urinate into a toilet or urinal have very poor aim and more often than not their stream of urine does not make it in the toilet but instead hits the walls, floors and even in some cases on the ceiling. Over time this creates a putrid smell of urine in the bathroom and creates unsanitary conditions if not sanitized properly. The problem of teaching male toddlers to aim their stream of urine into the toilet has occurred since this invention of the toilet with various ways of teaching the toddlers to aim there urine into the toilet or urinal.

Sometimes cereal is placed in the toilet bowl and the toddlers are instructed to aim at the cereal and hit the cereal with their stream of urine. This method of teaching works well because the toddler has a target for his urine to hit. The reason this method works is because the toddler has a target to hit and is concentrating on hitting the target. However, the problem with the cereal method of teaching urination is that cereal has to be placed in the toilet each time prior to urination and toddlers are not very reliable of placing cereal in the toilet each time they have to urinate, especially when the call to urinate is urgent. The other problem with this method is that when the cereal floats to the side of the toilet bowl the chance the stream of urine will end up on the exterior of the toilet bowl is greatly increased due to the toddler's lack of hand and eye coordination.

### BRIEF DESCRIPTION OF PRIOR ART

In an example of prior art, a bull's eye is painted in the middle of the toilet bowl or urinal, this method works very well but the problem is the paint is applied from the factory and cannot be removed without damaging the porcelain finish of the toilet bowl after the bull's eye is no longer need for training the toddler. Another problem is this method will not work with existing toilets that have already been manufactured. As shown by U.S. Pat. No. 7,373,673 issued to Holland on May 20, 2008.

In another example of prior art, a target is permanently mounted in a toilet bowl or urinal of an existing toilet or urinal. The problem with this invention is that the target is permanent and cannot be removed after the process of training the male to urinate in the toilet or urinal is completed. Also, having a toilet(s) in a house with a permanent bull's-eye or target may have the affect of reducing the resale value of a house because many buyers would not be receptive to having a permanent target or bull's-eye in a toilet bowl. As shown by U.S. Pat. No. 4,044,405 issued to Kreiss on Aug. 30, 1977.

### SUMMARY OF THE INVENTION

The present invention provides a toilet training aid that can be applied temporarily to the inside of an existing toilet or urinal in order to help teach male toddlers to keep their concentration and work on their hand and eye coordination of aiming their stream of urine into a toilet or urinal.

The present invention is a waterproof self adhesive mark that is applied directly to the porcelain of an existing toilet bowl or urinal where the urine stream is to be aimed. The waterproof self adhesive mark is uniquely designed to help the toddler work on his hand and eye coordination while keeping his concentration on hitting the mark with his stream of urine. By concentrating on aiming at the waterproof self adhesive mark in the toilet bowl or urinal, the toddler's hand and eye coordination develops quicker and as a result the toddler's stream of urine hits the interior of the toilet bowl or urinal instead of the floor, walls or exterior parts of the toilet bowl. The present invention helps teach male toddlers to concentrate their stream of urine in the toilet or urinal instead of outside the toilet or urinal. After the process of teaching the male toddler to urinate in the toilet or urinal is complete, the temporary mark can easily be removed from the toilet bowl or urinal without any damage to the finish of the toilet bowl or urinal.

### BRIEF DESCRIPTION OF THE DRAWINGS

FIG. 1 is a perspective view of a preferred embodiment of the toilet training aid of the present invention.

FIG. 2 is a perspective view of a first alternative embodiment of the toilet training aid of the present invention.

FIG. 3 is a perspective view of a second alternative embodiment of the toilet training aid of the present invention.

FIG. 4 is the present invention of the toilet training aid depicted as being mounted inside a toilet bowl.

FIG. 5 is the present invention of the toilet training aid depicted as being mounted inside a urinal.

FIG. 6 is a cross section view of one of the embodiment of the toilet training aid.

### DETAILED DESCRIPTION OF THE INVENTION

For a better understanding of the present invention, reference may be made to the following detailed description taken in conjunction with the appended claims and accompanying drawing.

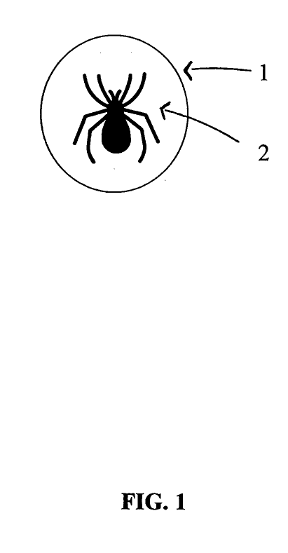

Referring to FIG. 1, the toilet training aid of the present invention is generally comprised of a waterproof self adhesive mark 1 with the design of an insect 2 on the face of the mark.

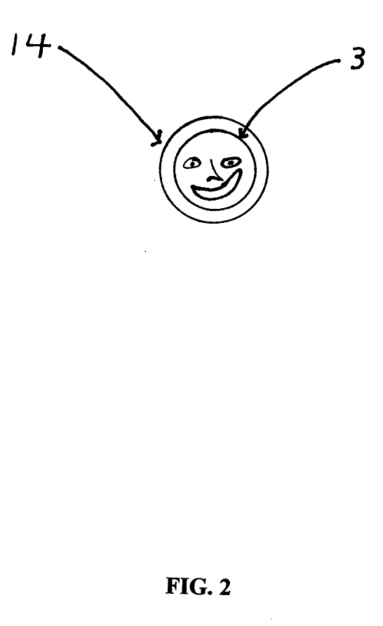

Referring to FIG. 2, the toilet training aid of the present invention is generally comprised of a waterproof self adhesive mark 14 with the design of a picture 3 on the face of the mark.

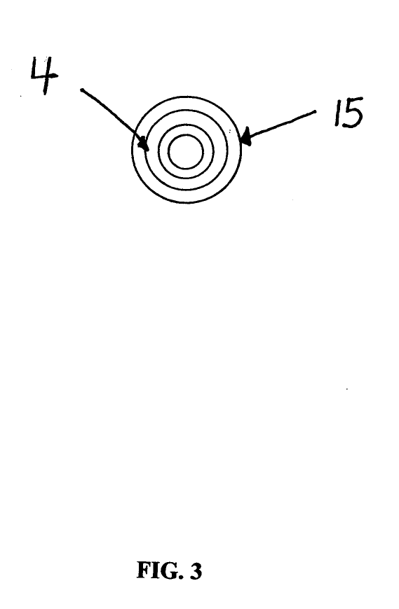

Referring to FIG. 3, the toilet training aid of the present invention is generally comprised of a waterproof self adhesive mark 15 with the design of a bull's eye 4 of different colored rings on the face of the mark.

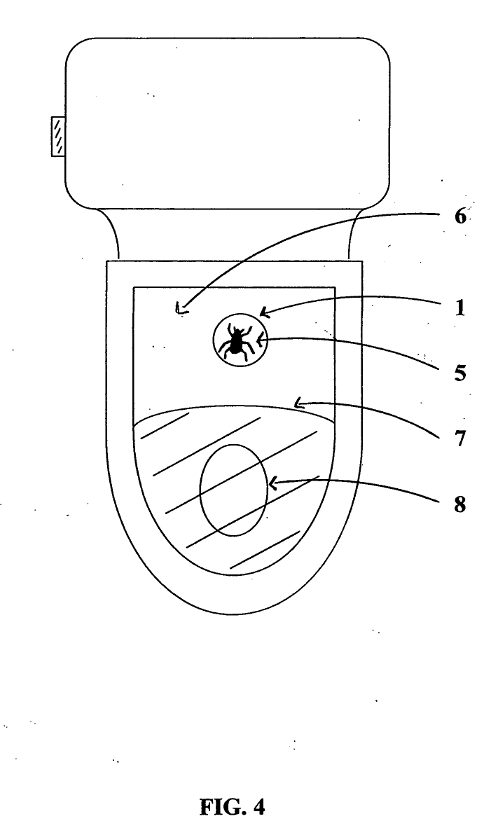

Referring to FIG. 4, the toilet training aid of the present invention is generally comprised of a waterproof self adhesive mark 1 with the design of an insect, lines or a picture 5 that is applied directly to the porcelain of the toilet bowl 6, at or below the waterline 7 of the toilet depending on the contour of the toilet and the depth of the waste outlet 8.

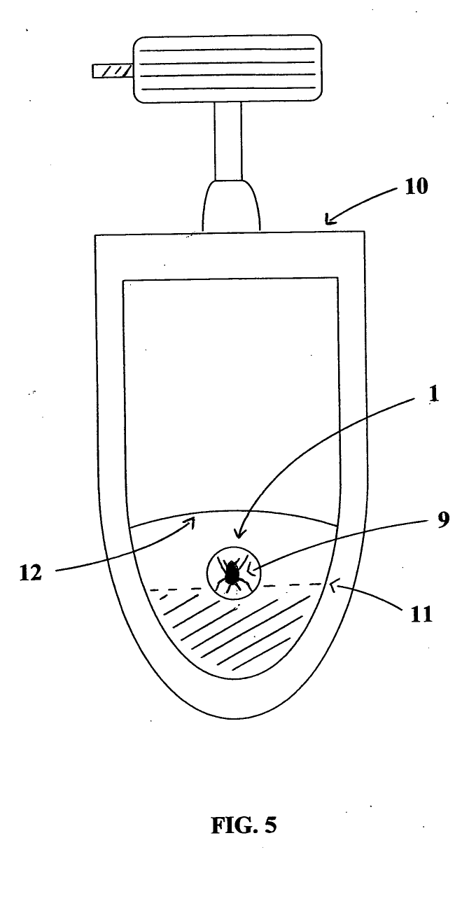

Referring to FIG. 5, the toilet training aid of the present invention is generally comprised of a waterproof self adhesive mark 1 with the design of an insect, lines or a picture 9 that is applied to the surface of the porcelain of a urinal 10, at or below the waterline 11 of the urinal depending on the contour of the urinal 12.

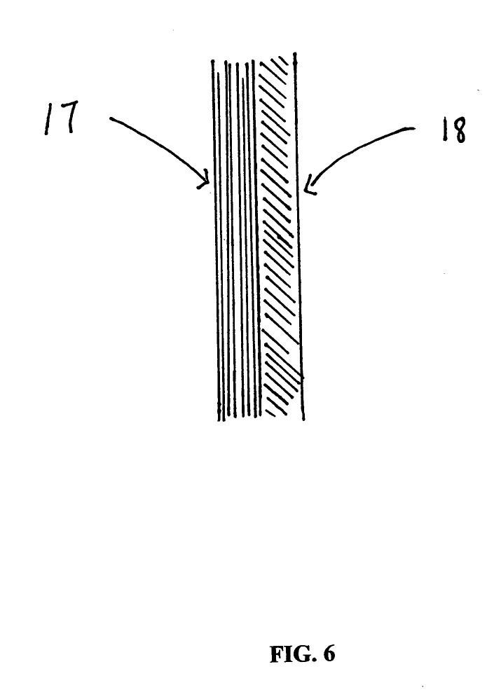

Referring to FIG. 6, is a cross section view of one of the embodiment of the toilet training aid mounted inside a toilet 6 and a urinal 10. The face of the marks 1, 14, and 15, are comprised of waterproof vinyl, plastic, or glow in the dark material 17 while the back of the mark is comprised of a waterproof self stick adhesive 18.

In the foregoing description, the present invention has been described with reference to specific exemplary embodiments thereof. It will be apparent to those skilled in the art that a person understanding this invention may conceive of changes or other embodiments or variations, which utilize the principle of this invention without departing from the broader spirit and scope of the invention. The specifications and drawing are, therefore, to be regarded in an illustrative rather than specific sense. Accordingly, it is not intended that the invention be limited except as may be necessary in view of the appended claims.

I claim:

1. A toilet training aid, comprising:
a waterproof self adhesive mark with an image on the face of the mark.

2. The toilet training aid of claim 1 wherein the mark is circular in shape.

3. The toilet training aid of claim 1 wherein the means for attaching the mark to the toilet is a waterproof self adhesive backing that is temporary and may be removed from the toilet without damage to the porcelain finish of the toilet.

4. The toilet training aid of claim 1 wherein the mark is comprised of waterproof vinyl or plastic or metallic or glow in the dark material.

5. The adhesive used for the mark is waterproof and capable of being submerged underwater without losing its adhesive qualities.

6. The toilet training aid of claim 1 wherein the mark has lines or an image or a picture on the face of the mark.
